(19) United States
(12) Patent Application Publication
(10) Pub. No.: US 2003/0090956 A1
(43) Pub. Date: May 15, 2003

(54) Method and device for mixing oil-containing liquids having multiple viscosities

(76) Inventors: Roy F. Knight, Norman, OK (US); William Bryant Bickerstaff, Chickasha, OK (US); Teddy M. Pledger, Broken Arrow, OK (US); R. William Graham, Oklahoma City, OK (US)

Correspondence Address: R. William Graham, 3340 Rosewood Lane, Oklahoma City, OK, 73120, US

(21) Appl. No.: 10/054,104

(22) Filed: Nov. 12, 2001

(51) Int. Cl. B01F 7/20

(52) U.S. Cl. 366/138; 366/262; 366/348

(57) ABSTRACT

A method and device are described for mixing an oil-containing liquid stored in an oil storage tank to determine the monetary value of said oil-containing liquid contained therein. The method comprises rotating an agitating device in the oil-containing liquid; providing a mixed oil-containing liquid; and determining the monetary value of the oil in said oil-containing liquid. The device includes a shaft disposed in the tank and extending along a central axis of the tank. The shaft includes at least one arm structure extending outward from the shaft so that when the shaft is rotated, the arm structure causes the liquid components to be mixed. The shaft is rotated by a power actuating device which may be a fuel powered motor, an electric powered motor a wind turbine or a manual hand crank.

### BACKGROUND OF THE INVENTION

1. Field of Invention

The present invention relates to the mixing of oil-containing liquids having different viscosities. More particularly, the present invention relates to a method and a device for mixing one or more layers of liquid in which each layer of liquid exhibits a consistent viscosity as distinguished from the other layers of liquid. Most particularly, the invention relates to a method and device for mixing a liquid media comprising low viscosity oil, medium viscosity oil, high viscosity oil and an aqueous media recovered from an oil or gas well to provide a mixed liquid medium.

2.Prior Art

Oil recovered from oil well sites is commonly stored in large oil storage tanks before being shipped via a pipeline, tanker trucks, etc., to the various purchasers of such oil. It is also common and well known that, in the oil producing processes, the production oil generally consists of different grades of oil having various viscosities. For example, the recovered oil-containing fluids typically consist of low viscosity oil, medium viscosity oil, high viscosity oil and aqueous fluids such as water and salt water. These various oil-containing liquids become separated in the tank in various layers depending upon the density of the components of the liquid.

In view of the separation of the oil-containing liquid into various layers in the storage tank, it is common practice for the purchaser, or an agent for the purchaser to sample the oil-containing liquid at various levels in the oil storage tanks in order to obtain a representative sample of the oil-containing liquid and arrives at a true value of the oil. Typically, samples are obtained from the tank as a representative sample of the oil-containing liquid in the tank. Quite often the number of samples taken and/or the placement of the device in the tank to take the samples results in an inaccurate reading of the percent and grade of oil in the tank.

In the past, some oil producers have built piping equipment with jet nozzles inside the tank to circulate the liquids using high pressure natural gas from the well. While the gas under pressure did in fact circulate the liquids inside the tank, it also mixed with the oil, temporarily increasing the volume of the oil-containing liquid inside the tank. The oil buyer who purchases a given number of barrels of the gas-containing oil, generally finds that, as the gas gradually leaves the oil, he is left with significantly fewer barrels of oil than he originally purchased. Presently, jet circulation is not generally practiced and some states have even passed regulations prohibiting and issue fines for such practice.

Other oil producers circulated the oil-containing liquid in the storage tanks using a pump and a suction hose to remove the aqueous liquid from the bottom of the tank and then returning oil to the top of the tank through a discharge hose. Since oil storage tanks hold several hundred barrels of liquid, several hours are required to start and complete the circulation process. This type of tank circulation system requires the oil producer to travel to the storage site; rig up the appropriate equipment; start the pump; monitor the pumping operation until completion; rig down the equipment; clean up the mess; and travel back to the office or shop. This is all performed at great expense and inconvenience to the oil producer. Presently, most oil producers do not circulate the oil-containing liquid in the storage tanks because it has not been cost effective. Therefore, there is a need in the field of oil recovery and storage for the accurate sampling of the oil content of the liquid contained in an oil storage tank.

Accordingly, the present invention provides a method and apparatus which allow for the accurate and rapid determination of the value of the oil-containing liquid in an oil storage tank without having to rely on the inaccurate and cumbersome procedures previous employed.

### SUMMARY OF THE INVENTION

It is an object of the invention to reduce the time, equipment and expense to circulate oil-containing liquid in oil storage tanks.

It is another object of the invention to use a cost efficient means such as wind actuated energy, solar actuated energy, fuel, e g., gas, actuated energy, electric actuated energy or manual actuated energy to power circulation of an oil-containing liquid in an oil storage tank.

It is still another object of the invention to reduce the time necessary for cleaning oil storage tanks

It is yet another object of the invention to provide a method and device whereby the value of oil in an oil-containing liquid can be determined conveniently and inexpensively.

In accordance with the invention, the oil-containing, liquid in an oil storage tank is subjected to rigorous agitation prior to determining the specific oil content of the oil-containing liquid to provide a liquid in which the various components of the liquid, i.e., the low viscosity oil, the medium viscosity oil, the high viscosity oil, and the aqueous components such as water and salt water, are uniformly mixed using an agitating device to provide a relatively uniform liquid in which the various components present a true concentration of the liquid in the tank.

Therefore, samples taken by various testers and from any location in the tank will result in very similar results.

The agitating device of the invention consists of a shaft extending into the tank through the oil containing liquid. Attached to the shaft are a plurality of arms which extend radially outward from the shaft. Upon rotation of the shaft, the arms provide an agitating motion upon the oil-containing liquid to cause the various liquid components to be mixed in a relatively uniform composition of the various components of the oil-containing liquid. The plurality of arms are strategically shaped and arranged along the shaft such that the plurality of the arms cause agitating motion at every level of the oil-containing liquid to insure that the entire volume of oil-containing liquid is uniformly mixed.

The shaft extends outward from the tank and engages a device which causes rotation of the shaft. The device may be a turbine, propeller, vane or the like which is powered by natural sources such as wind, the device may be powered by mechanical or electrical means such as a gas or electrical motor, or the device may be manually powered using a hand crank. Preferably, the device is powered by wind motion.

### BRIEF DESCRIPTION OF THE DRAWINGS

FIG. 1 is a side view showing, in partial cross section, the circulation device of the present invention using a wind turbine as the power source;

FIG. 2 is a side view showing, in partial cross section, the circulation device of the present invention using a wind vane as the power source,

FIG. 3 is a side view showing, in partial cross section, the circulation device of the present invention using an electric motor as the power source;

FIG. 4 is a side view showing, in partial cross section, the circulation device of the present invention using a gas motor as the power source;

FIG. 5 is a side view showing, in partial cross section, the circulation device of the present invention using a hand crank as the power source; and

FIG. 6 is a side view showing, in partial cross section, the circulation device of the invention using support means to secure the power actuating device to the tank

### DETAILED DESCRIPTION OF THE INVENTION

In accordance with the invention, the value of an oil-containing liquid in an oil storage tank can be readily determined without the need for unreliable techniques and other arbitrary decisions made by the oil producer or by the oil purchaser. Furthermore, there is no need to rely on the untrustworthy and cost ineffective method of the past to provide a uniform oil mixture. According to the invention, the oil-containing liquid is subjected to agitation prior to determining the specific oil content of the oil-containing liquid to provide a liquid in which the various oil components of the liquid, i.e., the low viscosity oil, the medium viscosity oil, the high viscosity oil, and the aqueous components such as water and salt water, are uniformly mixed to provide a single relatively uniform liquid in which the various components are distributed in the liquid at a concentration which is representative of or corresponds to the separate individual components in the tank. Therefore, samples taken by various testers and from any location in the tank will more likely result in accurate readings. The oil-containing liquid is dispersed by rotating a plurality of dispersing means such as arms, blades, paddles, fins, and the like. The mixing means are powered by wind motion, by mechanical or electrical power or by manual power. Preferably, the source of power is wind simply because there is no cost involved with operating the device, and there is almost always a wind blowing in the geographical areas where oil is being produced and stored.

The present invention provides not only a convenient and economical method and device for uniformly mixing an oil-containing liquid, and a method and device for determining the value of oil in an oil-containing liquid, but also provides a method and device which significantly prevents sludge build-up due to the circulation of the oil-containing liquid.

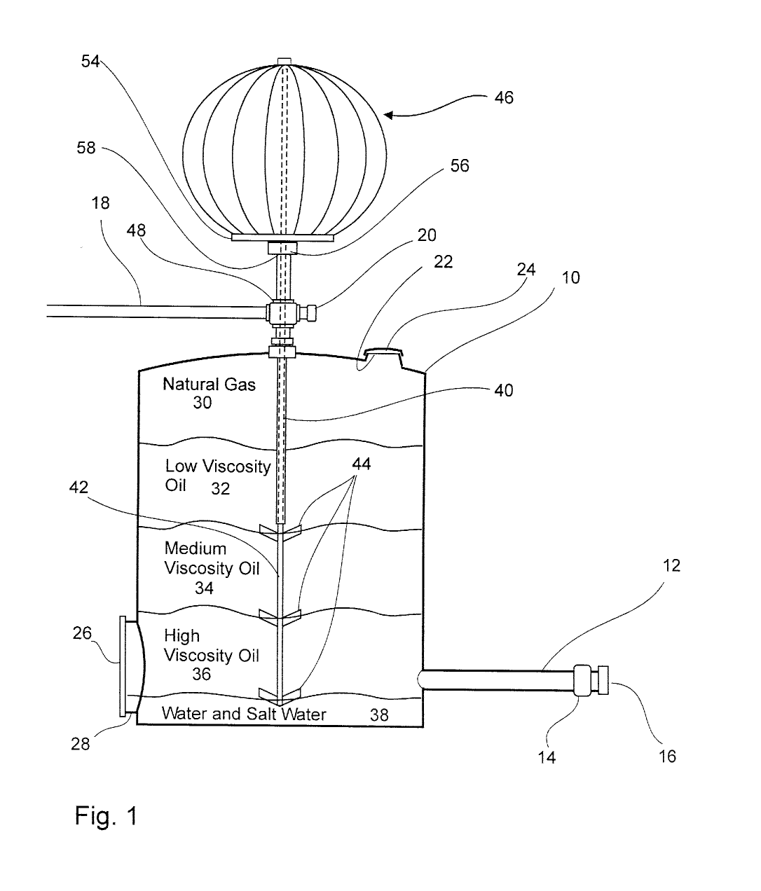

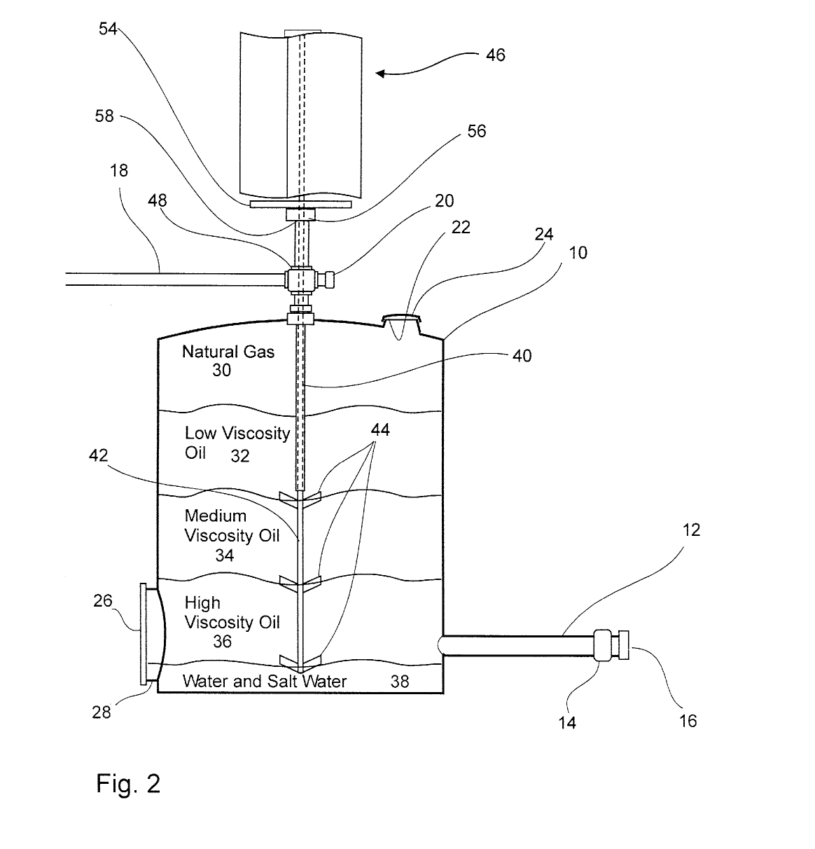

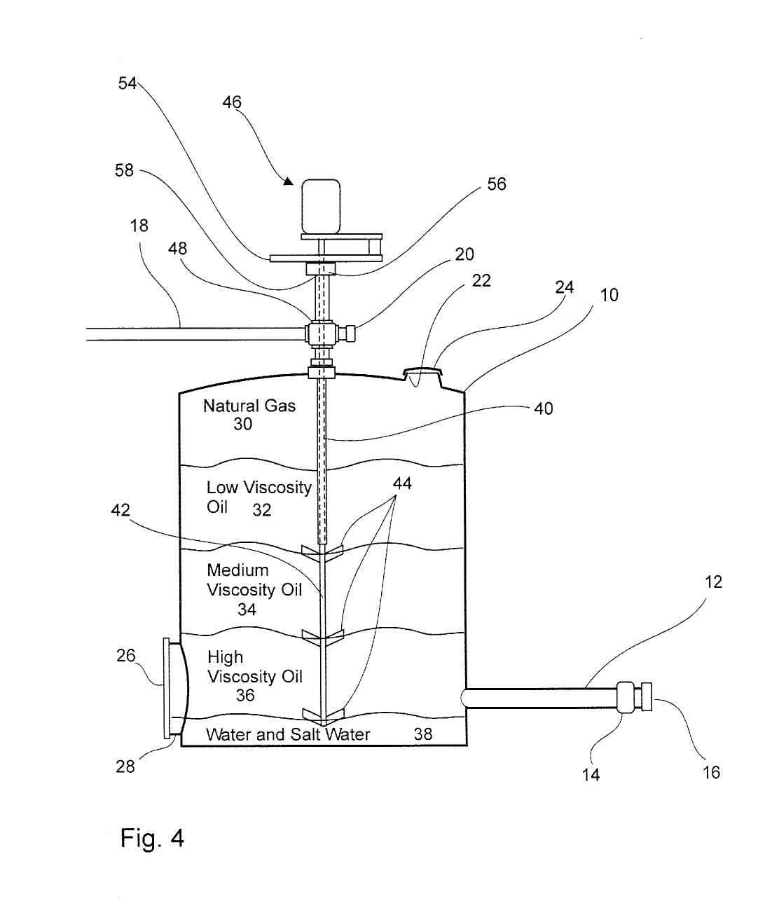

As illustrated in FIGS. 1-5, an oil storage tank 10 consists of a tubular sales pipe 12 connected to a bottom of the storage tank 10. The sales pipe 12 contains a valve 14 for regulating the flow of oil-containing liquid from the storage tank 10. The sales pipe 12 further contains an end plug 16 at the end of the sales pipe 12. A vent pipe 18 is located at a top of the storage tank 10 to vent gas (oil storage tanks are not generally designed to withstand high pressure). An end plug 20 may be removed to connect the vent pipe 18 to adjacent tanks. Also at the top of the storage tank 10 there is located a sampling or liquid inspection port 22 containing a cap 24. A manhole 26 for periodic cleaning of the storage tank 10 is located near the bottom of the storage tank 10. A manhole plate 28 is used to seal the manhole 26 and keep the liquids inside the storage tank 10. Inside the tank 10, the various liquids and gas are arranged in layers which comprise natural gas 30, low viscosity oil 32, medium viscosity oil 34, high viscosity oil 36 and aqueous fluids 38 which consist of water and salt water.

Extending downward from the top of the oil storage tank 10 is a stabilizing pipe 40 to provide sufficient support for a rotating shaft 42 which extends through the stabilizing pipe 40.

The rotating shaft 42 extends along a vertical central axis of the storage tank 10 and contains a plurality of arms 44 extending radially outward from the shaft 42. The arms 44 may be in the shape of blades, paddles, fins or other shape which effectively causes a mixing force on the oil-containing liquids Typically, the arms 44 are disposed along the shaft 42 so that some of arms 44 will rotate within, at least, one of the various layers of oil-containing liquid. The arms 44 may be in the form of sets of arms or the arms 44 may be arranged individually axially spaced along the shaft 42.

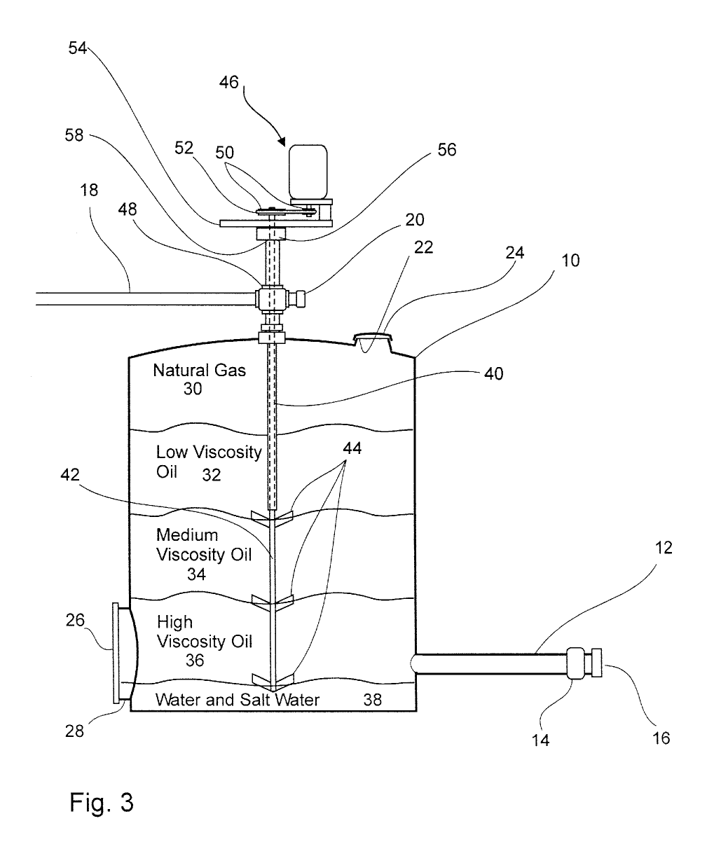

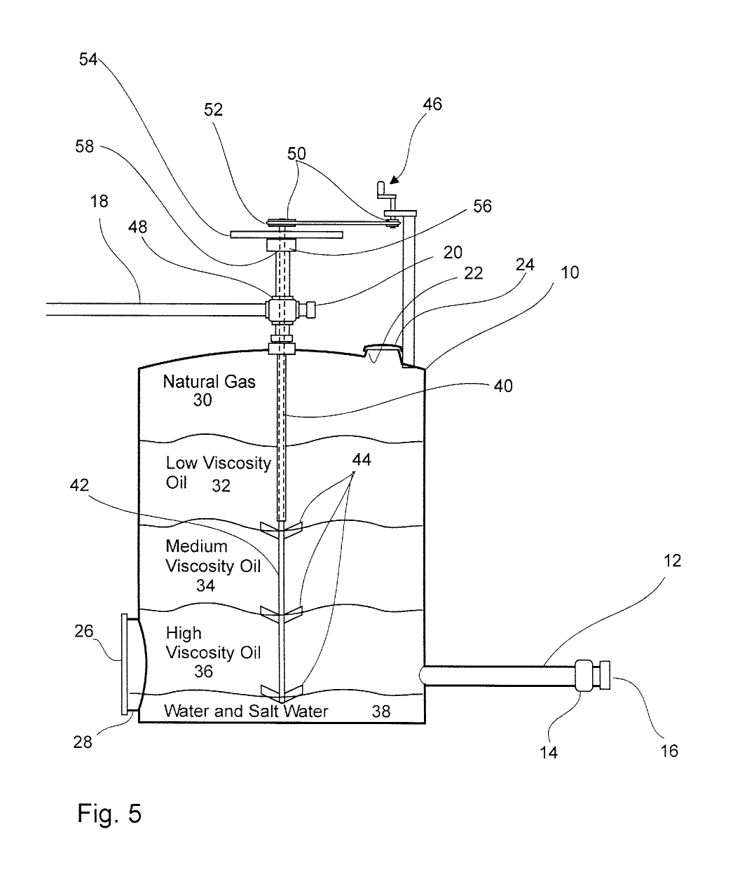

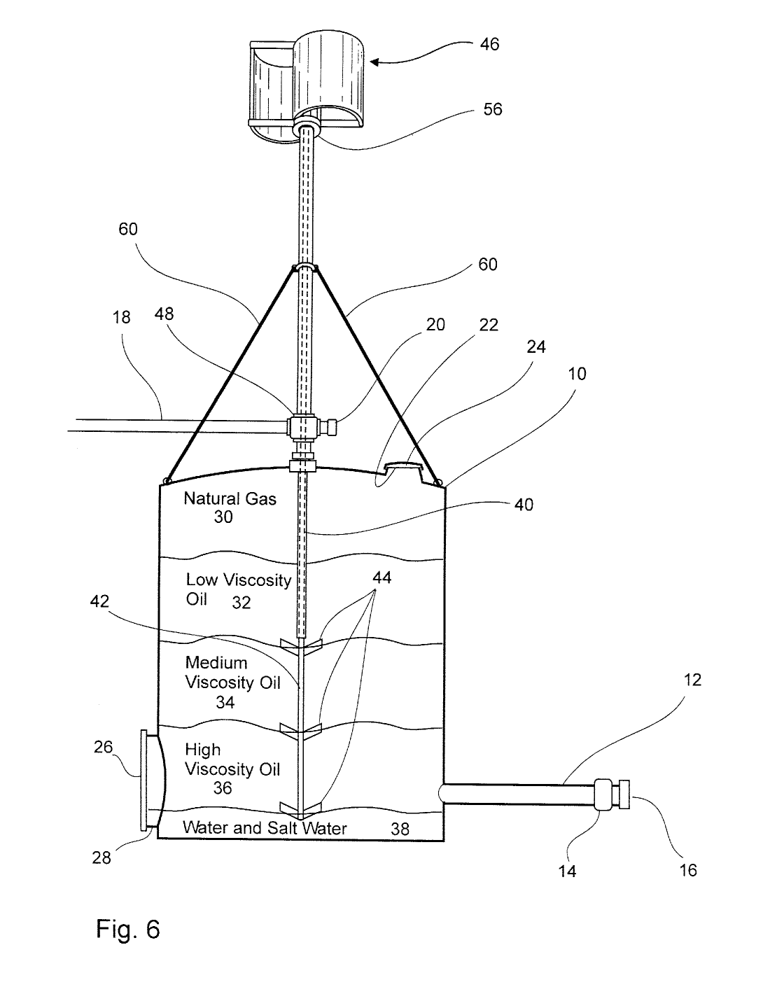

The shaft 42 further extends out of the oil storage tank 10 and engages a power actuating device 46 which powers the rotation of shaft 42 and, thus rotates the arms 44 causing the low viscosity oil 32, the medium liquid viscosity oil 34, the high viscosity oil 36, and the aqueous liquids 38 to be mixed. The shaft 42 is connected to the power actuating device 46 by coupler 48. The power actuating device 46 may engage the shaft 42 directly as seen in FIGS. 1, 2, 4 and 6 or the power actuating device 46 may engage the shaft via a pulley 50 and belt 52 as seen in FIGS. 3 and 5 The power actuating device 46 can be supported on a support platform 54. A load bearing 56 allows the power actuating device 46 to efficiently rotate on the support platform 54. A gas seal 58 can be provided to prevent the natural gas from leaking near the power actuating device 46. As seen in FIG. 6, the stabilizing pipe 40 surrounding the shaft 42 may be supported and secured to the oil-containing tank 10 by support means 60 which may be rigid support members or cables.

By employing the oil-containing mixing system of the present invention, the oil producer provides a uniformly mixed oil-containing medium where either or both the oil producer and the oil purchaser can quickly and inexpensively determine the value of the oil in an oil storage tank without resorting to expensive and time consuming testing.

Having described the present invention in detail and by reference to preferred embodiments thereof, it will be apparent that modifications and variations are possible without departing from the spirit and scope of the appended claims.

What is claimed is:

1. A method for mixing an oil-containing liquid stored in an oil storage tank to determine the value of the oil contained therein comprising:
providing a rotating agitating device in an oil-containing liquid of an oil storage tank;
providing a mixed oil-containing liquid;
sampling said mixed oil containing liquid; and
determining the monetary value of said oil based on said mixed oil-containing liquid.

2. The method of claim 1, wherein said oil-containing liquid comprises low viscosity oil, medium viscosity oil, high viscosity oil, and an aqueous liquid.

3. The method of claim 2, wherein said aqueous liquid contains water and salt water.

4. The method of claim 1, wherein said agitating device includes arms radially disposed outwardly from a shaft extending through said oil containing liquid.

5. The method of claim 4, wherein said shaft engages a power actuating device, said power actuating device causing said shaft to rotate.

6. The method of claim 5, wherein said power actuating device includes one of a gas powered motor, an electrical powered motor, a wind powered device and a hand crank.

7. The method of claim 6, wherein said power actuating device is disposed at least partially outside of said storage tank.

8. A device for dispersing an oil-containing liquid stored in a oil storage tank to determine the monetary value of the oil contained therein, said device comprising:
a shaft disposed in the oil storage tank;
at least one arm extending outward from said shaft into the liquid; and
a power actuating device engaging said shaft for rotating said shaft

9. The device of claim 8, wherein said shaft extends at least partially outwardly from said tank and connects to said power actuating device.

10. The device of claim 8, wherein power actuating device is one of a gas powered motor, an electric powered motor, a wind powered device and a manual powered device.

11. The device of claim 8, wherein said at least one arm structure includes a plurality of arm structures extending outward from said shaft into the liquid.

12. The device of claim 11, wherein said plurality of arm structures extend radially outward from said shaft.
